(19) United States
(12) Patent Application Publication
(10) Pub. No.: US 2009/0322535 A1
(43) Pub. Date: Dec. 31, 2009

(54) CAR SECURITY SYSTEM

(76) Inventor: JI SHIN, Etobicoke (CA)

Correspondence Address: James Ray & Associates, 2640 Pitcairn Road, Monroeville, PA, 15146, US

(21) Appl. No.: 12/494,558

(22) Filed: Jun. 30, 2009

Related U.S. Application Data
(60) Provisional application No. 61/133,656, filed on Jun. 30, 2008.

(51) Int. Cl. G08B 13/14

(52) U.S. Cl. 340/572.1

(57) ABSTRACT

The present invention in several embodiments is a device that can be utilized by car owners to prevent their vehicle from being stolen from the vicinity of their home. This product is linked to a security system found in a home. The main component of this product is a motion detector, which may look similar to a traditional garage door opener. This device is set within the vehicle, under a seat, on the dashboard or in another area of the vehicle. If a car is being stolen from a person's driveway, when it is a predetermined distance from the alarm system of the home, the motion detector will activate the alarm to the home alarm system. This will allow consumers to know their car is being tampered with.

### CROSS REFERENCE TO RELATED APPLICATION

This patent application is related to and claims priority from U.S. Provisional Patent Application Ser. No. 61/133,656 filed Jun. 30, 2008.

### FIELD OF THE INVENTION

This invention generally pertains to security systems and alarms. More specifically, the present invention relates to a vehicle security system for detecting when a vehicle is moved without proper authorization.

### BACKGROUND OF THE INVENTION

The invention is particularly applicable to car security systems and home security systems. Many automobiles are stolen from right in front of the owner's home. This may occur when no one is home or during the night. These owners have no way to be notified that their vehicle is being stolen. Many thefts occur without the criminals breaking the windows or damaging the doors. Some may be towed from the owner's driveway. Many of the car security systems are actually car recovery devices that must be activated by the user. That is the user needs to report the missing vehicle before any action is taken. There is a need for a car security system that is integrated into a monitored home security system. So that when a vehicle is moved from the proximity of a home the owner and authorities are notified, before the vehicle is far from the home.

Accordingly, it has been considered desirable to develop a new and improved car security system which would overcome the foregoing difficulties and others while providing better and more advantageous overall results

### SUMMARY OF THE INVENTION

The present invention in several embodiments is a device that can be utilized by car owners to prevent their vehicle from being stolen from the vicinity of their home. This product is linked to a security system found in a home. The main component of this product is a motion detector, which may look similar to a traditional garage door opener. This device is set within the vehicle, under a seat, on the dashboard or in another area of the vehicle.

If a car is being stolen from a person's driveway, when it is a predetermined distance from the alarm system of the home, the motion detector will activate the alarm to the home security system. This will allow consumers to know their car is being tampered with. The car security system will alert the home security system by a predetermined method. Law enforcement personnel can also be notified by the alarm system. If the home alarm system is a system that is monitored by a security service, then the security service will be made aware of the alarm and will be able to take appropriate action to protect the vehicle and notify the owner. This system may be produced as an addition to existing security systems or as an option for new home security systems.

The motion detector could operate by any means known in the art to detect the movement of a vehicle. For example, the motion detector could utilize accelerometers, radar, ultrasonic sensors, radio frequency signal strength, or the like or some combination of these means to detect the unauthorized movement of a targeted vehicle.

### OBJECTS OF THE INVENTION

It is therefore one of the primary objects of the present invention to provide a wireless vehicle security system.

Another object of the present invention is to provide a wireless vehicle security system that isn't integrated into a vehicle's power system.

Yet another object of the present invention is to provide a wireless vehicle security system that communicates with a home security system.

Still another object of the present invention is to provide a wireless vehicle security system that deters or prevents vehicle theft by towing.

Yet still another object of the present invention is to provide a wireless vehicle security system that quickly alerts vehicle theft by towing to the owner and the security monitoring service personnel.

In one embodiment the invention is a wireless theft detection device comprising: at least one receiver, at least one transmitter, at least one antennae, at least one microelectronic processor, at least one sensor capable of detecting motion, at least one battery, wherein said wireless theft detection device is capable of wirelessly communicating with a home security system. In another embodiment the wireless theft detection device further comprises a speaker. In another embodiment the wireless theft detection device further comprises a light. In another embodiment the home security system is monitored by a security service center. In another embodiment said at least one sensor capable of detecting motion comprises at least one accelerometer. In another embodiment said at least one sensor capable of detecting motion comprises at least one radio frequency device for measuring radio signal strength of said home security system. In another embodiment the wireless theft detection device further comprises an electronic display. In another embodiment the wireless theft detection device further comprises a keypad. In another embodiment the electronic display is a touch screen interface.

In yet another embodiment the invention is a wireless theft detection device comprising: at least one receiver, at least one transmitter, at least one antennae, at least one microelectronic processor, at least one sensor capable of detecting motion, at least one battery, at least one speaker, at least one light, at least one electronic display, wherein said wireless theft detection device is capable of wirelessly communicating with a home security system monitored by a security service center. In still another embodiment said electronic display is a touch screen interface. In yet another embodiment the wireless theft detection device further comprises a keypad. In yet still another embodiment said at least one sensor capable of detecting motion comprises at least one accelerometer. In yet another embodiment said at least one sensor capable of detecting motion comprises at least one radio frequency device for measuring radio signal strength of said home security system. In still yet another embodiment said at least one sensor capable of detecting motion comprises at least one ultrasonic sensor.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention; and together with the description serve to explain the principles and operation of the invention.

### BRIEF DESCRIPTION OF THE DRAWINGS

FIG. 1 is a general frontal view drawing of a preferred embodiment of the present invention.

FIG. 2 is a general perspective drawing of a preferred embodiment of the present invention being used in a vehicle.

FIG. 3 is a schematic view of the components of a preferred embodiment of the present invention.

FIG. 4 is a schematic view of a preferred embodiment of the invention being used with a wireless capable home security system.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

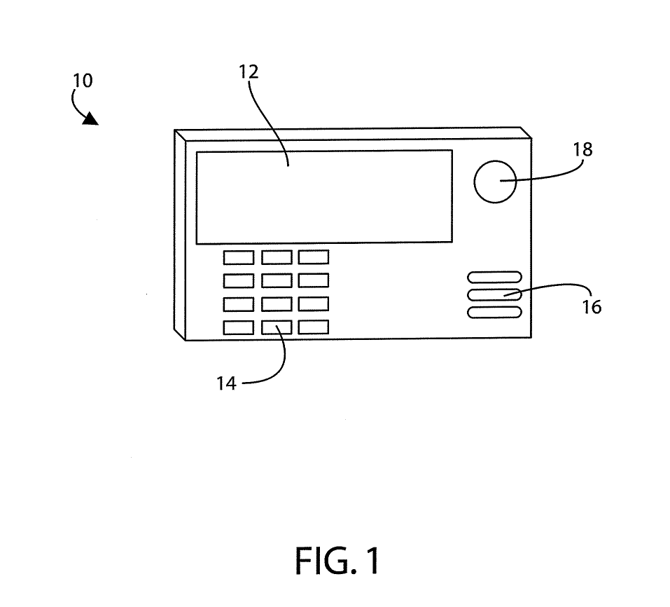

Reference is now made, more particularly, to FIG. 1 which is a general frontal view drawing of a preferred embodiment of the present invention. The motion detector 10 comprises an electronic display 12, a keypad 14, a speaker 16 and a light 18. In other embodiments of the present invention electronic display 12 and keypad 14 could be replaced by a touch screen user interface. Speaker 16 could be used as an alarm to deter potential thieves. Optionally, speaker 16 could be used to provide audio conformation to a user that the motion detector is armed. Light 18 could be used as a strobe light to an alarm to deter potential thieves.

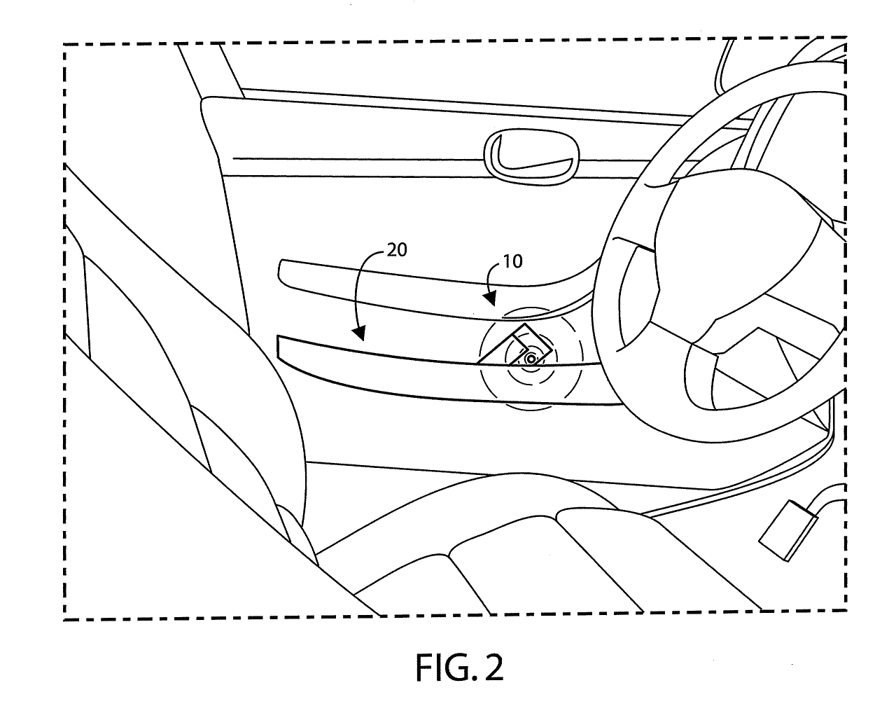

Reference is now made, more particularly, to FIG. 2 which is a general perspective drawing of a preferred embodiment of the present invention being used in a vehicle. Motion detector 10 could be placed anywhere inside a vehicle the user wants protected. Motion detector 10 could simply be placed in a door storage compartment 20, or anywhere inside the vehicle. In most embodiments of the present invention, motion detector 10 is completely battery powered and requires no wiring into a vehicle electrical system. Therefore, motion detector 10 could be easily moved from one vehicle to another by the user without tools.

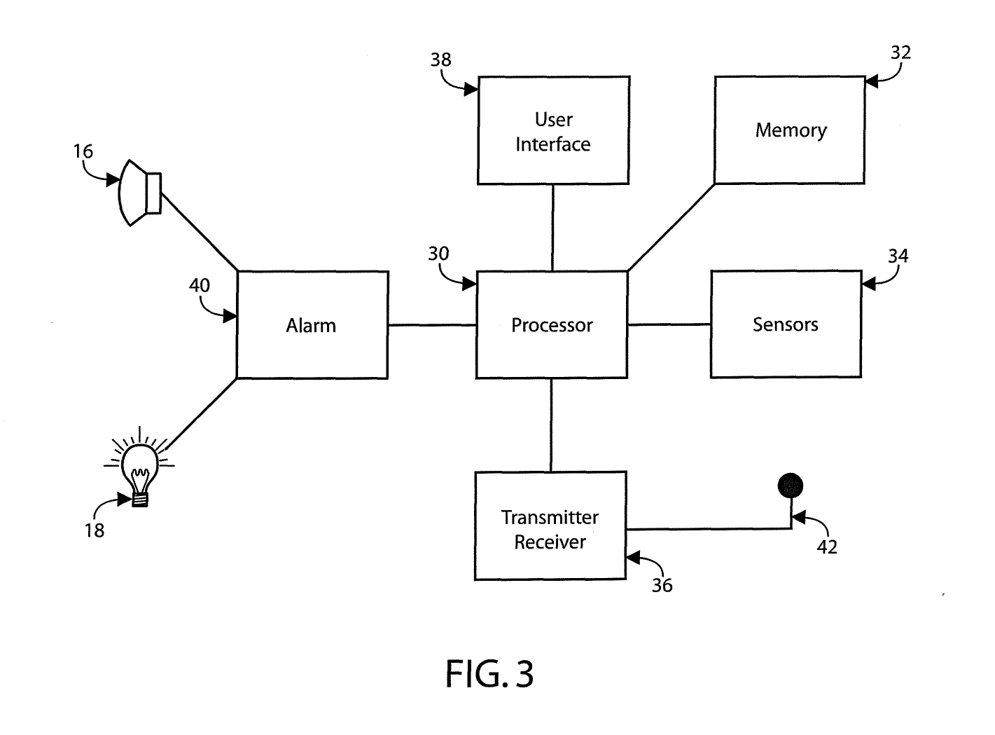

Reference is now made, more particularly, to FIG. 3 which is a schematic view of the component layout of one embodiment of the present invention. Processor 30 is coupled to memory 32, sensors 34, transmitter/receiver 36, user interface 38 and local alarm control 40. Transmitter/receiver 36 is further coupled to antenna 42. Local alarm control 40 is further coupled to speaker 16 and light 18. Memory 32 preferably includes both volatile and non-volatile forms of computer memory. Sensors 34 could comprise at least one accelerometer, ultrasonic sensor, or any other sensor that could detect movement, a change of position or change of location. Transmitter/receiver 36 could also be used to detect if motion detector 10 has moved out of a predetermined area by determining RF signal strength from a home security system. Transmitter/receiver 36 with coupled antenna 42 are used to communicate instruction and status information between home security system and motion detector 10. Local alarm control 40 provides control of speaker 16 and light 18. Speaker 16 could be set up to provide an audible alarm to deter thieves, wile light 18 could be set up to provide a visual deterrent.

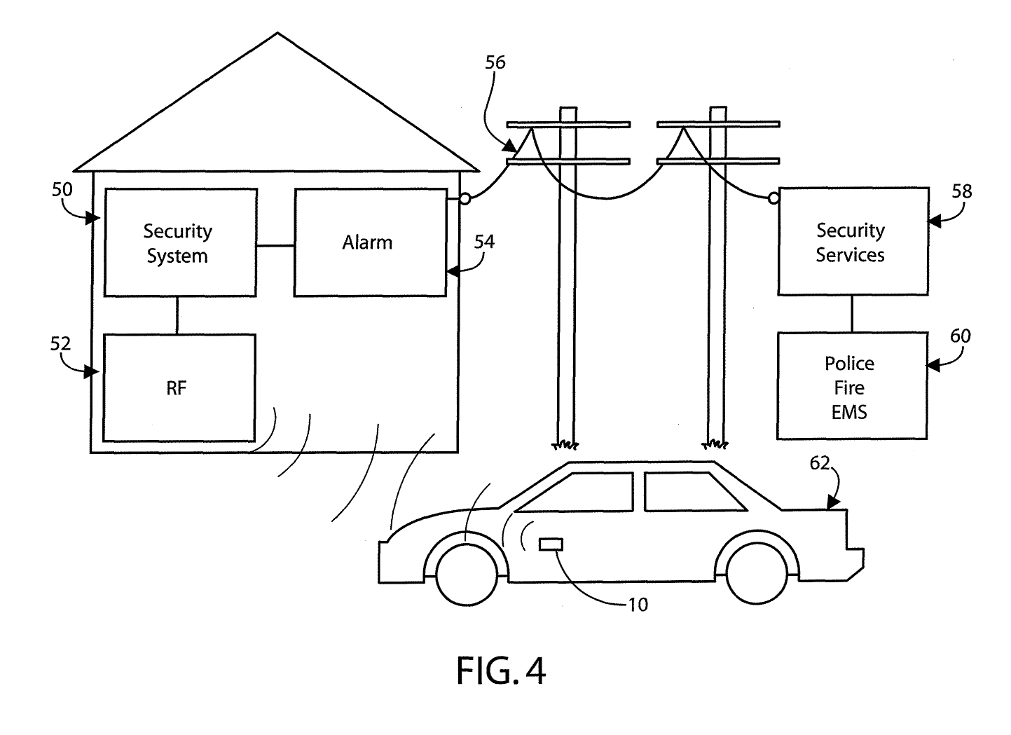

Reference is now made, more particularly, to FIG. 4 which is a schematic view of motion detector 10 functioning with home security system 50. Home security system could comprise radio frequency communication means 52 and alarm subsystem 54. Radio communication means 52 is preferably an RF transmitter/receiver. Alarm subsystem 54 is connected to a phone line 56 or the like, and communicates alarm information to a security service center 58. Security service center 58 then is able to take appropriate action which may include contacting emergency services 60, which could include contacting a police department, a fire department, an emergency medical system, private security personnel or a combination of the above. In practice when motion detector 10 is moved a predetermined amount motion detector 10 will send a RF signal to home security system 50 via radio communication means 52 indicating there is unauthorized movement of a vehicle 62. Home security system 50 then sends this information to alarm subsystem 54 which relays the information to security service center 58. Security service center 58 is then able to contact emergency services 60, and preferably contact the owner of the vehicle to inform them of the situation.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

What is claimed:

1. A wireless theft detection device comprising:
at least one receiver,
at least one transmitter,
at least one antennae,
at least one microelectronic processor,
at least one sensor capable of detecting motion,
at least one battery, wherein said wireless theft detection device is capable of wirelessly communicating with a home security system.

2. The wireless theft detection device of claim 1, further comprising a speaker.

3. The wireless theft detection device of claim 1, further comprising a light.

4. The wireless theft detection device of claim 1, wherein the home security system is monitored by a security service center.

5. The wireless theft detection device of claim 1, wherein said at least one sensor capable of detecting motion comprises at least one accelerometer.

6. The wireless theft detection device of claim 1, wherein said at least one sensor capable of detecting motion comprises at least one radio frequency device for measuring radio signal strength of said home security system.

7. The wireless theft detection device of claim 1, further comprising an electronic display.

8. The wireless theft detection device of claim 1, further comprising a keypad.

9. The wireless theft detection device of claim 7, wherein said electronic display is a touch screen interface.

10. A wireless theft detection device comprising:
at least one receiver,
at least one transmitter,
at least one antennae,
at least one microelectronic processor,
at least one sensor capable of detecting motion,
at least one battery,
at least one speaker,
at least one light,
at least one electronic display, wherein said wireless theft detection device is capable of wirelessly communicating with a home security system monitored by a security service center.

11. The wireless theft detection device of claim 10, wherein said electronic display is a touch screen interface.

12. The wireless theft detection device of claim 10, further comprising a keypad.

13. The wireless theft detection device of claim 10, wherein said at least one sensor capable of detecting motion comprises at least one accelerometer.

14. The wireless theft detection device of claim 10, wherein said at least one sensor capable of detecting motion comprises at least one radio frequency device for measuring radio signal strength of said home security system.

15. The wireless theft detection device of claim 10, wherein said at least one sensor capable of detecting motion comprises at least one ultrasonic sensor.

16. The wireless theft detection device of claim 10, wherein the wireless theft detection device is portable.

17. The wireless theft detection device of claim 10, wherein the wireless theft detection device is a handheld device.
